(19) United States
(12) Patent Application Publication
(10) Pub. No.: US 2019/0110488 A1
(43) Pub. Date: Apr. 18, 2019

(54) METHODS OF FLAVORING COLLAGEN CASINGS

(71) Applicant: Nitta Casings Inc., Bridgewater, NJ (US)

(72) Inventors: Eugene Goldfarb, South Amboy, NJ (US); David Mathews, Somerville, NJ (US); Stephen Hatch, Phillipsburg, NJ (US); Masanori Kishimoto, Osaka-fu (JP)

(21) Appl. No.: 16/151,421

(22) Filed: Oct. 4, 2018

Related U.S. Application Data
(60) Provisional application No. 62/627,970, filed on Feb. 8, 2018.
(60) Provisional application No. 62/572,601, filed on Oct. 16, 2017.

(51) Int. Cl. A22C 13/00

(52) U.S. Cl. CPC A22C 13/0016; A22C 2013/0046; A22C 2013/002

(57) ABSTRACT

A method for producing collagen casings having one or more flavor ingredients incorporated into the collagen is provided. The flavor ingredients may be added during processing of collagen to produce the collagen casing; prior to, during or after drying of the collagen casing; prior to, during or after humidification to add moisture to the collagen casing; prior to, during or after shirring of the collagen casing; prior to or after the casing has been stuffed with meat products; during cooking of the stuffed collagen casing; and/or prior to packaging of the meat product. The flavor ingredient may be a water based flavor ingredient, an oil based flavor ingredient, a powdered flavor ingredient, a microencapsulated flavor ingredient, or a combination of two or more of these types of flavor ingredients. Collagen casings having one or more flavor ingredients incorporated into the collagen casing are also provided.

This application claims priority pursuant to 35 U.S.C. § 119(e) to U.S. Provisional Application No. 62/627,970 filed on Feb. 8, 2018 and to U.S. Provisional Application No. 62/572,601 filed on Oct. 16, 2017, the entire contents of both of which are hereby incorporated by reference in their entirety.

The present invention is directed, in one aspect, to methods of flavoring a collagen casing by adding one or more flavor ingredients during processing of collagen to produce the collagen casing; prior to, during or after drying of the collagen casing; prior to, during or after humidification to add moisture to the collagen casing; prior to, during or after shirring of the collagen casing; prior to or after the casing has been stuffed with meat products; during cooking of the stuffed collagen casing; and/or prior to packaging of the meat product. In another aspect, the invention is directed to collagen casings having added flavor ingredients incorporated into the collagen casing.

### BACKGROUND OF THE INVENTION

Reconstituted collagen is used in the manufacture of tubular casings for meats, such as sausages. The collagen used in these casings is typically derived from the corium layer of bovine hides. The collagen raw material is comminuted, and mixed with acid to form a collagen gel. The collagen gel is extruded to form a casing in the shape of a continuous tube. The casing may be neutralized by the injection of gaseous ammonia or by contact with a liquid salt solution. The casing is washed in water to remove neutralization salts, plasticized by passing it through successive liquid baths and dried while inflated. Examples of such processes are disclosed in U.S. Pat. Nos. 3,535,125, 3,821,439, 4,388,331, and 5,820,812, the entire contents of each of which are hereby incorporated by reference.

It is desirable in some cases to apply one or more flavorings to the casing to provide a desired flavor to the meat product. For example, it may be desirable to flavor a collagen casing with a composition typically referred to as smoke flavor to impart a “smoked” flavor and aroma to the meat product. Flavor ingredients are typically applied to the surface of collagen casings. For example, water based flavors are typically applied to the surface of a collagen casing after extrusion and prior to drying. Oil based flavors are typically applied after drying and prior to reeling of the casing. It would be desirable to have a collagen casing in which the flavor is incorporated into the collagen casing.

### SUMMARY OF THE INVENTION

The present invention is directed, in one aspect, to methods of flavoring collagen casing by adding one or more flavor ingredients during processing of collagen to produce the collagen casing; prior to, during or after drying of the collagen casing; prior to, during or after humidification to add moisture to the collagen casing; prior to, during or after shirring of the collagen casing; prior to or after the casing has been stuffed with meat products; during cooking of the stuffed collagen casing, and/or prior to packaging of the meat product. In another aspect, the present invention is directed to collagen casings having flavor ingredients incorporated into the collagen casing.

Edible collagen tubular casing is produced by processing the corium layer of animal hides. The corium layer is separated from the grain layer of the animal hide on a leather splitting machine. In one embodiment, the corium layer is treated with an ammonium sulfate solution, water washed, and further treated with citric acid/sodium citrate solution followed by a water wash. The treated corium layer is shredded and ground to reduce the particle size of the corium material. In one embodiment, the corium material is ground to a quarter grind having a particle size of about one-quarter of an inch. One or more flavor ingredients may be added to the ammonium sulfate solution, the water wash or the citric acid/sodium citrate solution.

The ground corium material is dispersed in water and shredded to form a hydrated mass. The shredded corium material is blended with a dispersion of acid and cellulose. In one embodiment, one or more flavor ingredients are added to the cellulose-acid dispersion, which is then blended with the ground corium material. In another embodiment, flavor is added during the blending of the cellulose-acid dispersion and the ground corium material.

After blending, the mixture of shredded corium material and the acid-cellulose dispersion are stored in an aging tank where the ground corium material is converted into a collagen gel. After conversion of the ground corium material to collagen gel in the aging tank, the collagen gel is pumped from the aging tank, homogenized, and stored in a storage tank. One or more flavor ingredients may be added to the collagen gel in the aging tank or during homogenization of the collagen gel.

The collagen gel is extruded to form a collagen casing. In one embodiment, the collagen gel is pumped from the storage tank and filtered prior to extrusion. The one or more flavor ingredients may be added to the collagen gel after pumping and filtering and prior to extrusion. Alternatively, one or more flavor ingredients may be added to the collagen casing after extrusion.

Following extrusion, the collagen casing is treated to neutralize the acid and coagulate the collagen. One or more flavor ingredients may be added to the collagen during or after neutralization.

After neutralization, the collagen casing is washed and sent through a plasticizer solution. The plasticizer solution may contain one or more flavor ingredients to impart flavor to the collagen casing.

The collagen casing is dried, and then sent through one or more humidification chambers. One or more flavor ingredients may be applied to the collagen casing after the drying step, or during or after the humidification step.

The finished collagen casing is shirred. One or more flavor ingredients may be added to the collagen casing before, during or after the shirring process. During shirring, one or more flavor ingredients may be added to the collagen casing internally through the mandrel.

One or more flavor ingredients may also be added to the collagen casing prior to or during packing of the collagen casing with meat. The flavor ingredients may also be added during cooking of a pre-cooked meat product, during the smoke cycle or just before packing of the meat product

One or more flavor ingredients may be added during more than one of the steps described above during the process of producing the collagen casing.

The one or more flavor ingredients added to the collagen gel may be water based flavor ingredients, oil based flavor ingredients, powdered flavor ingredients, microencapsulated flavor ingredients or combinations of two or more of these ingredients. For example, a maple flavor, a pepperoni flavor, sweet and sour flavor, ranch dressing flavor, garlic, curry, jalapeno, onion, bacon, mustard, salt, pepper or combinations of these flavors may be added to the collagen gel. The invention is not limited in this regard, and any type of desired flavor ingredient may be added to the collagen gel to produce a flavored collagen casing.

In some embodiments, the collagen casings produced by the methods described herein comprise flavor ingredients incorporated into the collagen prior to extrusion of the collagen into a collagen casing. In these embodiments, the one or more flavor ingredients are uniformly distributed throughout the collagen. Collagen cases having one or more flavor ingredients distributed throughout the collagen are superior to collagen casings having flavor ingredients applied only to the surface of the collagen casing.

Among the advantages of the processes and products described and claimed are that a flavored collagen casing is produced in which the flavor is incorporated into the collagen, which can provide improved flavoring of the meat product packed into the collagen casing. Other advantages of the process and resulting product will be apparent to those skilled in the art based upon the description of embodiments of the invention set forth below.

### DESCRIPTION OF THE DRAWINGS

FIG. 1 is a schematic showing one embodiment of a process by which limed hides are processed into edible collagen casings, and illustrating where flavor ingredients may be injected into the collagen gel in various embodiments of the process.

### DESCRIPTION OF EMBODIMENTS OF THE INVENTION

The present invention is directed to methods of flavoring collagen casing by adding one or more flavor ingredients during processing of collagen to produce the collagen casing; prior to, during or after drying of the collagen casing; prior to, during or after humidification to add moisture to the collagen casing; prior to, during or after shirring of the collagen casing; prior to or after the casing has been stuffed with meat products; during cooking of the stuffed collagen casing, and/or prior to packaging of the meat product.

The flavor ingredients may be water based solutions, oil based solutions, powdered ingredients, microencapsulated flavor ingredients or combinations of two or more of these types of flavor ingredients. In some embodiments, the flavor ingredient may be a smoke flavor, pepperoni flavor, sweet and sour flavor, maple flavor, ranch dressing flavor, garlic, curry, jalapeno, onion, bacon, mustard, salt, pepper or combinations of these flavors may be added to the collagen gel. It should be understood that the present invention is not limited to addition of these flavor ingredients, and that other types of flavor ingredients may be added to a collagen gel prior to extrusion using the present invention in the manner described below.

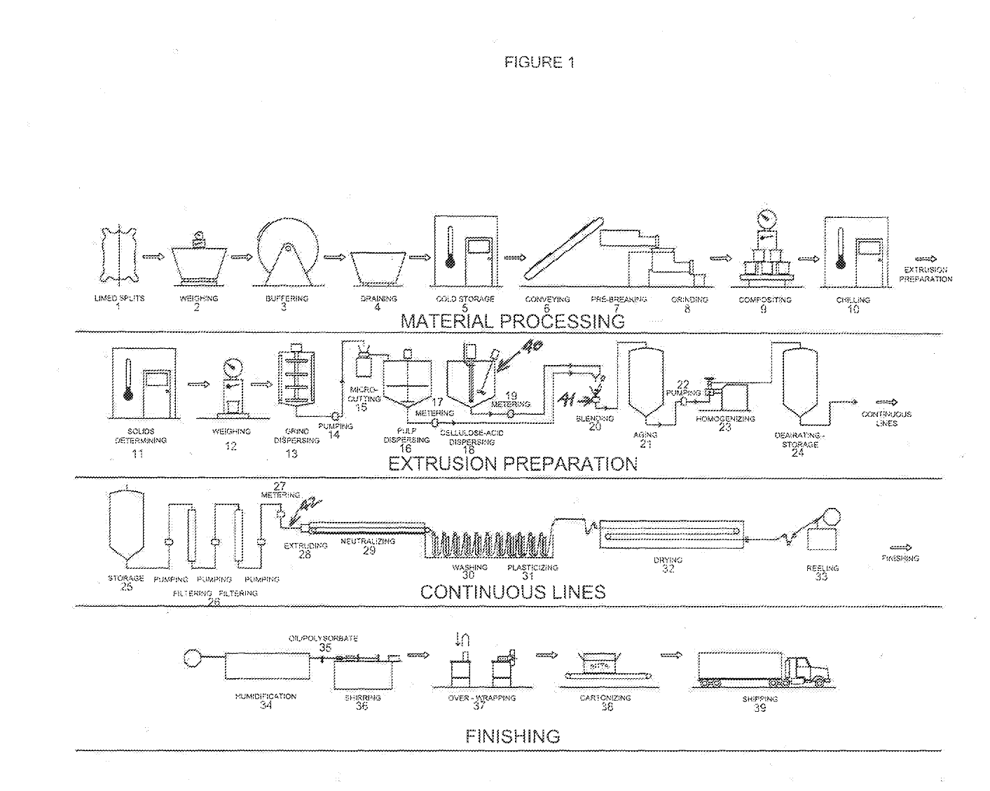

Conventional processes for producing edible collagen casings are known and have been described, for example, in U.S. Pat. No. 5,820,812, the entire contents of which are hereby incorporated by reference. The steps and equipment used in one embodiment of a typical process is shown schematically in FIG. 1. The present invention is not limited in this regard, and flavor ingredients may be added to collagen gel made by any process prior to extruding the collagen gel to produce a collagen casing.

In one typical process for producing collagen casings, animal hides from freshly slaughtered animals are de-fleshed, washed with water, and treated with lime to remove hair. The lime treated animal hides are split on a leather splitting machine to separate the grain layer from the corium layer, which is used to produce the collagen casings. Referring to FIG. 1, the limed corium layers 1 are stored in a refrigerated storeroom that is maintained at 0-4° C. until further processed as described below.

In the embodiment of the process shown in FIG. 1, the corium layers are first processed to prepare the corium material for extrusion into casings. The corium layers are weighed 2 and treated in a buffering drum 3, which is capable of handling up to 3000 Kg of product. In the buffering drum, the corium layers are treated with an ammonium sulfate solution, then water washed. In one embodiment, the ammonium sulfate concentration is in the range of about 0.5%-2.2% (w/w). The corium layers are then further treated with a citric acid/sodium citrate solution followed by another water wash. In one embodiment, the citric acid/sodium citrate concentration is in the range of about 0.0725-0.29% (w/w). One or more flavor ingredients may be added to the ammonium sulfate solution, citric acid/sodium citrate solution and/or the wash water. The buffering process brings the pH of the corium layer down to approximately 4.3 to 4.9. Assays are run to ensure the product reaches the appropriate pH. The buffered corium layers are drained 4 and the buffered corium layers are placed in cold storage 5 until needed for further processing.

When additional material is needed for processing, the corium layers are sent on a conveyor 6 to be shredded 7 and ground 8 into a quarter grind (i.e., a corium material having a particle size of about one-quarter inch) at less than approximately 25° C. One or more flavor ingredients may be added to the corium prior to or during shredding of the corium layers. The quarter grind corium material is composited 9 and chilled 10 and maintained at a temperature of about 18° C.

The chilled quarter grind corium material is piped to the extrusion preparation line. The solids are measured 11 and weighed 12 and the quarter grind corium material is dispersed in water 13. One or more flavor ingredients may be added to the water used to make the quarter grind dispersion. The dispersed quarter grind corium material is pumped 14 to a high speed cutting mill 15 where the corium material is further shredded to form a hydrated mass. The hydrated mass is stored and kept mixed in a pulp dispersion tank 16. One or more flavor ingredients may be added to the hydrated corium mass in the pulp dispersion tank. In a separate blending tank 18, a dispersion of cellulose, HCl and water at 0 to 10° C. is prepared. The dispersion may be prepared, for example, at 5° C. In one embodiment, one or more flavor ingredients are added 40 to the cellulose-acid dispersion.

A quantity of the hydrated quarter grind corium material from the pulp dispersion tank 16 is metered 17 into a blender 20. At the same time, a quantity of the cellulose-acid dispersion from blending tank 18 is metered 19 into the blender 20 and blended with the hydrated quarter grind corium materials to form a gel product. Alternatively, one or more flavor ingredients may be added 41 into the blender 20 and combined with the corium material and the cellulose-acid dispersion.

After an initial blend period of about 15 to 60 minutes, the gel product is stored in an aging tank 21 for about 20 hours under vacuum. One or more flavor ingredients may be added to the gel product while it is stored in the aging tank 21. The temperature of the aging tank is maintained at less than 20° C. The gel product is then pumped 22 to a homogenizer 23. In one embodiment, one or more flavor ingredients is added to the collagen during homogenization. After the collagen gel is homogenized, it is sent to a deaeration/storage tank 24 where it is deaerated under vacuum. One or more flavor ingredients may be added to the gel product while it is stored in the deaeration/storage tank 24. The gel product so obtained has the following approximate composition:

| Ingredient | Percent |
|---|---|
| Hide Solids | 4.2 to 5.3 |
| Cellulose | 0.90 to 1.70 |
| Hydrochloric Acid | 0.20 to 0.24 |

The gel product is maintained in storage tank 25 at about 25° C. One or more flavor ingredients may be added to the gel product while it is stored in the deaeration/storage tank 25. The gel product is pumped from the storage tank through a series of filters 26, which may be any appropriate type of filter. Automatic self cleaning filters may be used. In one embodiment, one or more flavor ingredients are added 42 to the collagen gel prior to extrusion, and after the pumps and filters 43. The filtered gel product is metered 27 to the extruder 28 to form the collagen casing. The extruder is preferably a disk extruder. At the extruder, the gel is typically extruded to a thickness from 0.075 to 1.2 thousands, formed, and inflated pneumatically to the desired diameter, typically about 13-34 mm.

Following extrusion, the collagen casing is treated with anhydrous ammonia in the neutralizing section 29. The ammonia reacts with and neutralizes the HCl in the product and causes coagulation of the collagen. One or more flavor ingredients may be added to the collagen casing after extrusion and before neutralization. Alternatively, one or more flavor ingredients may be added during or after the neutralization step.

The neutralized collagen casing is washed in a fresh water bath 30 to remove ammonia salts. One or more flavor ingredients may be added to the water in the fresh water bath. The washed collagen casing then travels through a series of baskets 31 containing the plasticizer. The plasticizer solution is an aqueous solution containing about 2% to 6% glycerin, about 0.20% to 1.6% sodium carboxymethylcellulose or sodium alginiate, and about 0 to 20 ppm sodium hypochlorite. This process dehydrates the casing for drying purposes and allows introduction of glycerin for elasticity purposes. One or more flavor ingredients may be added to the plasticizer solution to impart flavor to the collagen casing.

The collagen casing travels through a dryer 32, which uses dry heat up to 205° F. The dryer may have multiple stages at different temperatures. One or more flavor ingredients may be added to the collagen casing before, during or after the drying step. After drying, the collagen casing is sent through a humidification chamber (not shown) at approximately 85% relative humidity. One or more flavor ingredients may be added to the collagen casing before, during or after the humidification step.

The collagen casing is collapsed and wound on a reel 33. One or more flavor ingredients may be added to the collagen casing before reeling. The reeled collagen casing is run through a second humidification chamber where final moisture is added to the casing. One or more flavor ingredients may be added to the collagen casing when the final moisture is added to the casing. The casing is then sent for finishing and shipment.

During the finishing process, moisture is added back to the casing by humidification 34. Then the product is shirred 36 to its specified length and placed in boxes that are over wrapped and vacuum packed 37. One or more flavor ingredients may be added to the collagen casing before, during or after the shirring process. During the shirring process, one or more flavor ingredients may be added to the collagen casing internally through the mandrel used in the shirring process.

The finished collagen casings are then boxed into FDA approved cardboard boxes 38, which are labeled, bar coded and scanned into the company's lot control system for traceability purposes. The ventilated boxes of slugs may then be placed in a humidification chamber, where forced humidified air is used to bring the moisture content of the product within specifications.

One or more flavor ingredients may be added to the collagen casing prior to or during the packing of the collagen casing with meat. The flavor ingredients may also be added during cooking of a pre-cooked meat product, during the smoke cycle or just before packaging of the meat product.

The collagen casing produced by the processes described herein have flavor ingredients incorporated in the collagen. As a result, the flavor ingredients are more stable and better able to remain intact, thereby providing better flavor to the meat product that is stuffed into the collagen casing. While specific embodiments have been described herein, the invention is not limited to these embodiments, and the flavor ingredients may be added at any desired step in the process of producing a collagen casing.

As will be recognized by those of ordinary skill in the pertinent art based on the teachings herein, numerous changes and modifications may be made to the above-described and other embodiments of the invention without departing from its scope. For example, one skilled in the art will recognize that multiple extrusion preparation lines and multiple storage tanks for the gel product may be used to ensure a constant supply to the continuous extrusion line. Accordingly, this detailed description of preferred embodiments is to be taken in an illustrative as opposed to a limiting sense.

We claim:

1. A method for flavoring a collagen casing comprising the steps of:
(a) separating the corium layer from the grain layer of an animal hide; and
(b) processing the corium layer to produce a collagen casing, wherein at least one flavor ingredient is added to the collagen casing during processing of collagen to produce the collagen casing; prior to, during or after drying of the collagen casing; prior to, during or after humidification to add moisture to the collagen casing; prior to, during or after shirring of the collagen casing; prior to or after the casing has been stuffed with meat products; during cooking of the stuffed collagen casing; and/or prior to packaging of the meat product.

2. The method of claim 1, wherein the step of processing the corium layer to produce a collagen casing further comprises the steps of:
(i) grinding the corium layer of one or more animal hides and dispersing the ground corium in water;
(ii) blending the ground corium material dispersed in water with a dispersion of cellulose and acid to produce a collagen gel;
(iii) adding a flavor ingredient to the collagen gel; and
(iv) extruding the flavored collagen gel to form a collagen casing.

3. The method of claim 1 further comprising the step of shirring the collagen casing wherein a flavor ingredient is added to the collagen casing through a mandrel during shirring.

4. The method of claim 1 further comprising the step of exposing the collagen casing to a plasticizer solution comprising a flavor ingredient.

5. The method of claim 1, wherein the flavor ingredient is selected from the group consisting of water based flavor ingredients, oil based flavor ingredients, powdered flavor ingredients, microencapsulated flavor ingredients and combinations thereof.

6. The method of claim 2, wherein the flavor ingredient is a water soluble smoke flavor ingredient.

7. The method of claim 1, wherein the flavor ingredient is added to the dispersion of cellulose and acid prior to blending the dispersion of cellulose and acid with the ground corium material.

8. The method of claim 1, wherein the flavor ingredient is added during blending of the ground corium material with the dispersion of cellulose and acid.

9. The method of claim 2, wherein the flavor ingredient is selected from the group consisting of smoke flavor, pepperoni flavor, sweet and sour flavor, maple flavor, ranch dressing flavor, garlic, curry, jalapeno, onion, bacon, mustard, salt, pepper or combinations thereof.

10. A collagen casing comprising collagen from the corium layer of an animal hide and at least one flavor ingredient, wherein the flavor ingredient is incorporated into the collagen prior to extrusion of the collagen into a collagen casing.

11. The collagen casing of claim 10, wherein the flavor ingredient is selected from the group consisting of water based flavor ingredients, oil based flavor ingredients, powdered flavor ingredients, microencapsulated flavor ingredients and combinations thereof.

12. The collagen casing of claim 10, wherein the flavor ingredient is a water soluble smoke flavor ingredient.

13. The collagen casing of claim 10, wherein the flavor ingredient is selected from the group consisting of smoke flavor, pepperoni flavor, sweet and sour flavor, garlic, curry, jalapeno, onion, bacon, mustard, salt, pepper or combinations thereof.

14. A collagen casing comprising collagen from the corium layer of an animal hide and at least one flavor ingredient, wherein the flavor ingredient is uniformly distributed throughout the collagen.

15. The collagen casing of claim 14, wherein the flavor ingredient is selected from the group consisting of water based flavor ingredients, oil based flavor ingredients, powdered flavor ingredients, microencapsulated flavor ingredients and combinations thereof.

16. The collagen casing of claim 15, wherein the flavor ingredient is a water soluble smoke flavor ingredient.

17. The collagen casing of claim 16, wherein the flavor ingredient is selected from the group consisting of smoke flavor, pepperoni flavor, sweet and sour flavor, garlic, curry, jalapeno, onion, bacon, mustard, salt, pepper or combinations thereof.
